(19) United States
(12) Patent Application Publication
(10) Pub. No.: US 2012/0060775 A1
(43) Pub. Date: Mar. 15, 2012

(54) ENERGY RECOVERY SYSTEM FOR AN INTERNAL COMBUSTION ENGINE ARRANGEMENT, COMPRISING THERMOELECTRIC DEVICES

(75) Inventor: Luc Aixala, Soucieu-en-Jarrest (FR)

(73) Assignee: RENAULT TRUCKS, Saint Priest (FR)

(21) Appl. No.: 13/254,164

(22) PCT Filed: Mar. 31, 2009
(86) PCT No.: PCT/IB09/05651

§ 371 Date: Aug. 31, 2011

(51) Int. Cl. F02B 63/00

(52) U.S. Cl. 123/2

(57) ABSTRACT

An energy recovery system includes a main line capable of carrying the exhaust gases of an engine, at least a first and a second thermoelectric devices capable of producing electricity by Seebeck effect, the second thermoelectric device being located downstream from the first thermoelectric device, the thermoelectric devices each having an optimum temperature range and a highest admissible temperature. The optimum temperature range and the highest admissible temperature of the second thermoelectric device are lower than the optimum temperature range and the highest admissible temperature of the first thermoelectric device, respectively. The system further includes a controller for controlling the flow rate of the exhaust gases passing against the second thermoelectric device, in order to prevent the second thermoelectric device from being exposed to temperatures exceeding its highest admissible temperature.

### BACKGROUND AND SUMMARY

The present invention relates to an internal combustion engine arrangement for an automotive vehicle, especially an industrial vehicle. More specifically, the invention relates to an energy recovery system for such an engine arrangement.

A conventional internal combustion engine arrangement comprises an exhaust line capable of collecting exhaust gas from the engine, for example through an exhaust manifold. A significant amount of energy is included in said exhaust gases, which have a high speed and a high temperature.

Several systems have been designed to recover at least part of this energy, in order to improve the vehicle efficiency, more particularly the engine arrangement efficiency, which has a direct impact on fuel consumption. One conventional system consists of equipping the exhaust line with one or several thermoelectric devices using the Seebeck effect. Such a thermoelectric device is capable of producing electricity by the conversion of a heat flux between the hot exhaust gases flowing in the exhaust line and a cold source. The generated electricity can then be used for the operation of various elements of the vehicle, and/or can be stored in an energy storage component such as a battery.

However, one important limit of this conventional system is that the flow rate and temperature of the exhaust gases can vary in a quite wide range, depending on the engine operating conditions. Thus, the thermoelectric device is exposed to varying levels of hot temperature and of heat flux. As a consequence, the efficiency of the thermoelectric device can be poor, when the exhaust gases temperature is far from the optimum temperature range of said thermoelectric device. There may even be a risk of damaging the thermoelectric device in case the exhaust gases temperature becomes higher than the highest admissible temperature of said thermoelectric device.

It therefore appears that, from several standpoints, there is room for improvement in engine arrangements regarding energy recovery.

It is desirable to provide an improved energy recovery system, which can overcome the drawbacks encountered in conventional engine arrangements.

It is also desirable to provide an energy recovery system for an internal combustion engine arrangement which better uses the energy contained in the exhaust gases and which prevents any damage caused to the thermoelectric device(s).

According to an aspect of the invention an energy recovery system comprises:
a main line capable of carrying the exhaust gases of the engine;
at least a first and a second thermoelectric devices capable of producing electricity by Seebeck effect by the conversion of the temperature difference between the hot exhaust gases flowing in the main line and a cold source, the second thermoelectric device being located downstream from the first thermoelectric device, said thermoelectric devices each having an optimum temperature range and a highest admissible temperature; wherein the optimum temperature range and the highest admissible temperature of said second thermoelectric device are lower than the optimum temperature range and the highest admissible temperature of said first thermoelectric device, respectively, and wherein the system further comprises control means for controlling the flow rate of the exhaust gases passing against the second thermoelectric device, in order to prevent said second thermoelectric device from being exposed to temperatures exceeding its highest admissible temperature. The optimum temperature range of the thermoelectric device is the temperature range where there is a maximum conversion efficiency, i.e. where the voltage that can be generated by the thermoelectric device from a given temperature difference is maximal. The highest admissible temperature is the temperature above which the thermoelectric device can be damaged. In the system according to the invention, the first thermoelectric device is designed to withstand hot temperatures, corresponding preferably at least to the highest possible temperature of the exhaust gases at the location of the device in the exhaust line. Thus, this first thermoelectric device cannot be damaged in normal operating conditions. Furthermore, its optimum temperature range is quite high. As a result, since it is the first thermoelectric device in the exhaust line, it is exposed to a still high temperature of exhaust gases and therefore provides a satisfactory efficiency.

As regards the second thermoelectric device, the invention provides means which ensure both a protection from overheating and an optimum efficiency, depending on the engine operating conditions. In concrete terms, the control means are capable of controlling the flow rate of the exhaust gases passing against the second thermoelectric device. This control can be continuous, over the full range of the total flow rate of exhaust gases, i.e. between 0% and 100% of the total flow. This control can also be discrete, for example with various predefined settings, and/or it may extend over only a part of the range of the total flow. Said control means can be piloted by the exhaust gases temperature and/or by the exhaust gases flow rate, for example upstream from the first thermoelectric device, i.e. by the engine operating conditions.

If the exhaust gases are very hot, the control means can limit or even can stop the flow passing against the second thermoelectric device, in order to prevent it from overheating. On the contrary, if the exhaust gases temperature is lower, the control means can allow the whole flow of exhaust gases to pass against the second thermoelectric device, provided the exhaust gases temperature at the second thermoelectric device inlet is below its highest admissible temperature.

Moreover, the control means can allow only part of the exhaust gases to pass against the second thermoelectric device. This can occur, for example, when the exhaust gases have an intermediate temperature. By reducing the exhaust gases flow rate, the exhaust gases temperature can decrease quickly along the main line, so that it is below the second thermoelectric device highest admissible temperature when the exhaust gases reach said device inlet. Therefore, in this case, the invention makes it possible to use at least part of the energy contained in the exhaust gases.

With the invention, it is possible to increase the energy recovered thanks to having several thermoelectric devices which have different optimum operating temperature ranges, and to improve the overall efficiency of the system while also protecting the thermoelectric devices without needing a pre cooler.

In an implementation of the invention, the system can comprise additional control means for controlling the electric power generated by the first thermoelectric device.

For example, in case the exhaust gases have a quite low temperature and/or a quite low flow rate, it can be envisaged to decrease the power generated by the first thermoelectric device or even to deactivate said first thermoelectric device. Indeed, this ensures that the second thermoelectric device is exposed to a temperature which has not be lowered below its optimum temperature range, so that said second thermoelectric device can have a good efficiency. It has to be noted that the—at least partial—deactivation of the first thermoelectric device does not substantially impair the overall efficiency since the efficiency of said first thermoelectric device is poor when the exhaust gases temperature is below its optimum temperature range. Deactivating (at least partially) the first thermoelectric device can also ensure that the exhaust gases temperature downstream from the second thermoelectric device is high enough to enable a good efficiency of an after-treatment device such as a SCR (selective catalytic reduction) system. Preferably, the—at least partial—deactivation of the first thermoelectric device is not obtained by a control of the flow rate of the exhaust gases. In other words, the first thermoelectric device is not shielded and is still exposed to all the exhaust gases flow.

For example, the additional control means are designed to control the flow and/or the temperature of the cold source to which the first thermoelectric device is associated, and/or to control the electrical output of the first thermoelectric device.

According to an embodiment of the invention, the system comprises a secondary line having an inlet connected to the main line between the first and the second thermoelectric devices and an outlet connected to the main line downstream from said second thermoelectric device, the system further comprising a valve capable of directing one part of the exhaust gases flowing in the main line towards the second thermoelectric device and the other part of said exhaust gases towards the secondary line. Said secondary line can comprise a secondary thermoelectric device capable of producing electricity by Seebeck effect by the conversion of a heat flux between the hot exhaust gases flowing in the secondary line and a cold source, said secondary thermoelectric device having an optimum temperature range and a highest admissible temperature higher than the optimum temperature range and the highest admissible temperature of said second thermoelectric device, respectively.

With this arrangement, the invention makes it possible to recover part of the energy still contained in the exhaust gases, downstream from the first thermoelectric device, while the second thermoelectric device has been bypassed. For example, the secondary thermoelectric device can have the same optimum temperature range and highest admissible temperature as the first thermoelectric device. In a possible embodiment, these devices can be identical. In another possible embodiment, the secondary thermoelectric device can have an optimum temperature range and a highest admissible temperature which are intermediate between those of the first and second thermoelectric devices.

For example, the optimum temperature range of the first thermoelectric device is about 300° C.-5000 C and the optimum temperature range of the second thermoelectric device is about 150° C.-300° C.

Typically, the highest admissible temperature of the second thermoelectric device can be lower than 400° C., for example around 350° C.-400° C.

It is envisaged that the first thermoelectric device comprises thermoelectric elements made of at least one material pertaining to the following group: (P—Zn4Sb3, n-Mg2Si), (p- and n-CoSb3). The second thermoelectric device comprises thermoelectric elements comprising Bi2Te3.

According to one embodiment of the invention, the system comprises a third thermoelectric device capable of producing electricity by Seebeck effect by the conversion of the temperature difference between the hot exhaust gases flowing in the main line and a cold source, said third thermoelectric device being located downstream from the second thermoelectric device, said third thermoelectric device having an optimum temperature range and a highest admissible temperature lower than the optimum temperature range and the highest admissible temperature of said second thermoelectric device, respectively, the system further comprising control means for controlling the flow rate of the exhaust gases passing against the third thermoelectric device, in order to prevent said third thermoelectric device from being exposed to temperatures exceeding its highest admissible temperature. In other words, the system according to the invention comprises three successive stages of thermoelectric devices along the main line, in the downstream direction, adapted to decreasing temperatures. The cold source can be the engine cooling fluid, an auxiliary cooling fluid and/or ambient air.

Each thermoelectric device can be connected to a battery and/or to one or more vehicular component that are electrically operated.

The invention also concerns an internal combustion engine arrangement comprising an energy recovery system as previously described.

These and other advantages will become apparent upon reading the following description in view of the drawing attached hereto representing, as non-limiting examples, embodiments of a vehicle according to the invention.

### BRIEF DESCRIPTION OF THE DRAWING

The following detailed description of several embodiments of the invention is better understood when read in conjunction with the appended drawing being understood, however, that the invention is not limited to the specific embodiments disclosed. In the drawing,

FIGS. 1, 2 and 3 are schematic drawings of an exhaust line of an internal combustion engine arrangement, according to a first, a second and a third embodiment of the invention, respectively.

### DETAILED DESCRIPTION

An internal combustion engine typically comprises an engine block defining a plurality of cylinders. Intake air is carried towards the engine, for feeding the cylinders, through an air intake line which can comprise an intake manifold. The gases formed in each cylinder can be collected by at least one exhaust line, which may comprise an exhaust manifold, and the exhaust gases are then carried towards the atmosphere by the exhaust line 1 which may comprise various exhaust gases after-treatment devices and silencers.

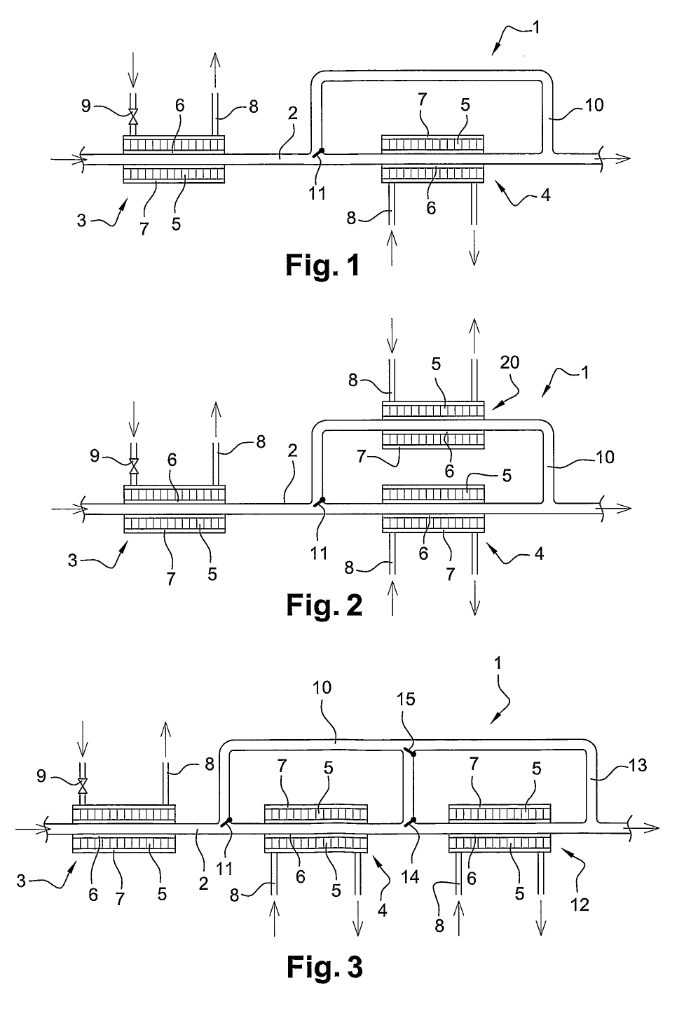

As shown in FIG. 1, the exhaust line 1 includes a main line 2 which comprises a first thermoelectric device 3 and a second thermoelectric device 4, located downstream from the first thermoelectric device 3. The thermoelectric devices 3, 4 are capable of producing electricity by Seebeck effect.

In the illustrated embodiments, the thermoelectric devices 3, 4 are substantially cylindrical and surround the main line 2. Each thermoelectric device 3, 4 comprises thermoelectric elements 5 arranged between an inner wall 6 and an outer wall 7. The inner wall 6 is located close to or in contact with the main line 2, so as to be thermally connected to the main line, in order to achieve a good heat transfer from the hot exhaust gases to the thermoelectric elements 5. Moreover, a coolant circuit 8 or a derivation thereof carries the engine cooling fluid and is thermally connected to the outer wall 7, i.e. to the other side of said thermoelectric elements 5 in order to achieve a good heat transfer from the thermoelectric elements 5 to the cooling fluid.

In the illustrated embodiments, the coolant circuit 8 is equipped with a valve 9, the aperture of which is controlled by controlling means (not shown), for example depending on the exhaust gases temperature and/or flow rate, and/or depending on the engine operating conditions. Furthermore, the thermoelectric devices 3, 4 are connected to an electrical circuit which may comprise one or more battery and/or one or more vehicular component that are electrically operated. The electrical circuit is preferably equipped with means for controlling the electrical current within said circuit. Each thermoelectric device can be equipped with its own independent electrical circuit, or they can share a common circuit.

The thermoelectric elements 5 comprise materials or set of materials which can convert the heat flux, which is due to the temperature difference between the hot exhaust gases flowing in the main line 2 and the coolant flowing in the coolant circuit 8, into electrical power.

In further embodiments—not shown´the cold source for the thermoelectric devices 3,4 can comprise, alone or in combination, an auxiliary coolant circuit, independent from the engine cooling circuit, such as an engine charge air cooling circuit or a vehicle cabin air conditioning circuit, and/or ambient air. Also, the different thermoelectric devices can be equipped with the same cold source or with different cold sources.

The exhaust line 1 includes a secondary line 10 having an inlet connected to the main line 2 between the first and second thermoelectric devices 3, 4 and an outlet connected to the main line 2 downstream from the second thermoelectric device 4. In other words, the secondary line is arranged in parallel to the portion of the main line on which the second thermoelectric device is located. At the upstream junction between the main line 2 and the secondary line 10, there is provided a valve 11 capable of directing one part of the exhaust gases flowing in the main line 2 towards the second thermoelectric device 4 and the other part of said exhaust gases towards the secondary line 10. As a result, the thermoelectric device 4 can be fully or partially by-passed when needed.

The first thermoelectric device 3 is designed to withstand high temperatures, which means that it can be exposed to the hot exhaust gases at all times, whatever the engine operating conditions. There is no need to protect it since its highest admissible temperature is higher than the highest possible temperature of the exhaust gases flowing in the main line 2 at the location of the first device 3. Furthermore, the first thermoelectric device 3 has a high optimum temperature range. Since it is located most upstream on the main line 2, this ensures that it is exposed to the exhaust gases when they are still very hot, thereby leading to a satisfactory efficiency of said first thermoelectric device 3.

For example, the first thermoelectric device 3 has an optimum temperature range of about 300° C.-500° C. and may include thermoelectric elements 5 comprising (p-Zn4Sb3, n-Mg2Si).

On the other hand, the second thermoelectric device 4 has a lower optimum temperature range, so that it can use the lower temperature of exhaust gases, downstream from the first thermoelectric device 3, to efficiency generate electricity. For example, this optimum temperature range is about 150° C.-300° C. This second thermoelectric device 4 may include thermoelectric elements 5 comprising Bi2Te3.

Such materials having a lower optimum temperature range generally also have a lower highest admissible temperature, typically lower than 400° C. or even 350° C. With the arrangement of FIG. 1, the second thermoelectric device 4 is used to generate electricity when the exhaust gases temperature is not too high, and may be at least partially by-passed when said temperature is too high, to protect it from overheating. The invention therefore ensures that the temperature of exhaust gases at the second thermoelectric device inlet never exceeds the highest admissible temperature of said second thermoelectric device 4. This makes it possible to use efficiently the energy of hot exhaust gases without damaging the thermoelectric devices 3, 4.

A second embodiment of the invention is shown in FIG. 2. It corresponds to an improvement of the first embodiment of FIG. 1, the secondary line 10 being provided with a secondary thermoelectric device 20 capable of producing electricity by Seebeck effect.

Said secondary thermoelectric device 20 has an optimum temperature range and a highest admissible temperature higher than the optimum temperature range and the highest admissible temperature of said second thermoelectric device 4, respectively. For example, the secondary thermoelectric device 20 is made with the same thermoelectric elements 5 as the first thermoelectric device 3, or even is identical to said first thermoelectric device 3.

With this arrangement, when the exhaust gases are very hot and therefore are—at least partially—directed towards the secondary line 10 to protect the second thermoelectric device 4 from overheating, the energy of said exhaust gases flowing in the secondary line 10 is not lost and can be used by secondary thermoelectric device 20 to generate electricity.

A third embodiment of the invention is illustrated in FIG. 3. A first, second and third thermoelectric devices 3, 4, 12 are successively provided on the main line 2. These devices have decreasing optimum temperature ranges and highest admissible temperatures from the first one to the third one.

Furthermore, the exhaust line 1 includes an additional branch 13 having an inlet connected to the secondary line 10 and an outlet connected to the main line 2 downstream from the third thermoelectric device 12. Valves 14, 15 are provided respectively at the downstream junction between the main line 2 and the secondary line 10, and at the junction between the additional branch 13 and the secondary line 10. The first thermoelectric device 3 is exposed to the exhaust gases at all times. Depending on the exhaust gases temperature and/or flow rate, the second and/or third thermoelectric devices 4, 12 are exposed on not to these gases, to protect them from overheating. The second and third thermoelectric devices 4, 12 can be independently exposed—or not—to the exhaust gases. Furthermore, it is possible to reactivate any of them whenever needed, at all times.

Similarly with the second embodiment of FIG. 2, it would also be possible to provide additional thermoelectric devices with appropriate optimum temperature ranges and highest admissible temperatures on the secondary line 10 and/or on the additional branch 13.

Of course, the invention is not restricted to the embodiments described above by'way of non-limiting examples, but on the contrary it encompasses all embodiments thereof.

1. An energy recovery system for an internal combustion engine arrangement, the system comprising:
a main line capable of carrying the exhaust gases of the engine;
at least a first and a second thermoelectric devices capable of producing electricity by Seebeck effect by the conversion of a heat flux between the hot exhaust gases flowing in the main line and a cold source, the second thermoelectric device being located downstream from the first thermoelectric device, the thermoelectric devices each having an optimum temperature range and a highest admissible temperature; wherein the optimum temperature range and the highest admissible temperature of the second thermoelectric device are lower than the optimum temperature range and the highest admissible temperature of the first thermoelectric device, respectively, and in that the system further comprises control means for controlling the flow rate of the exhaust gases passing against the second thermoelectric device, in order to prevent the second thermoelectric device from being exposed to temperatures exceeding its highest admissible temperature.

2. The system according to claim 1, wherein it comprises additional control means for controlling the electrical power generated by the first thermoelectric device.

3. The system according to claim 2, wherein the additional control means are designed to control the flow and/or the temperature of the cold source.

4. The system according to claim 1, wherein it comprises a secondary line having an inlet connected to the main line between the first and the second thermoelectric devices and an outlet connected to the main line downstream from the second thermoelectric device, the system further comprising a valve capable of directing one part of the exhaust gases flowing in the main line towards the second thermoelectric device and the other part of the exhaust gases towards the secondary line.

5. The system according to claim 4, wherein the secondary line comprises a secondary thermoelectric device capable of producing electricity by Seebeck effect by the conversion of the temperature difference between the hot exhaust gases flowing in the secondary line and a cold source.

6. The system according to claim 5, wherein the secondary thermoelectric device has an optimum temperature range and a highest admissible temperature higher than the optimum temperature range and the highest admissible temperature of the second thermoelectric device, respectively.

7. The system according to claim 1, wherein the optimum temperature range of the first thermoelectric device is about 300° C.-500° C. and the optimum temperature range of the second thermoelectric device is about 150° C.-300° C.

8. The system according to claim 1, wherein the highest admissible temperature of the second thermoelectric device is lower than 400° C.

9. The system according to claim 1, wherein the first thermoelectric device comprises thermoelectric elements made of at least one material pertaining to the following group: (P—Zn4Sb3, n-Mg2Si), (p- and n-CoSb3).

10. The system according to claim 1, wherein the second thermoelectric device comprises thermoelectric elements comprising Bi2Te3.

11. The system according to claim 1, wherein it comprises a third thermoelectric device (12) capable of producing electricity by Seebeck effect by the conversion of the temperature difference between the hot exhaust gases flowing in the main line and a cold source, the third thermoelectric device (12) being located downstream from the second thermoelectric device, the third thermoelectric device (12) having an optimum temperature range and a highest admissible temperature lower than the optimum temperature range and the highest admissible temperature of the second thermoelectric device, respectively, the system further comprising control means (14) for controlling the flow rate of the exhaust gases passing against the third thermoelectric device (12), in order to prevent the third thermoelectric device from being exposed to temperatures exceeding its highest admissible temperature.

12. The system according to claim 1, wherein the cold source comprises the engine cooling fluid, an auxiliary cooling fluid and/or ambient air.

13. The system according to claim 1, wherein each thermoelectric device is connected to a battery and/or to one or more vehicular component that are electrically operated.

14. An internal combustion engine arrangement, comprising a system according to claim 1.
